(19) United States
(12) Patent Application Publication
(10) Pub. No.: US 2017/0011828 A1
(43) Pub. Date: Jan. 12, 2017

(54) Manufacturing Method for Magnet and Magnet

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/200,531

(22) Filed: Jul. 1, 2016

(30) Foreign Application Priority Data
Jul. 8, 2015 (JP) 2015-136765

(51) Int. Cl. H01F 1/055; B22F 1/02; H01F 41/02; B22F 1/00

(52) U.S. Cl. CPC H01F 1/0551; B22F 1/007; B22F 1/02; H01F 1/0556; H01F 41/0266

(57) ABSTRACT

A manufacturing method for a magnet includes performing pressure molding in which mixed powder of magnetic powder and a lubricant is molded under pressure so as to promote cracking of the magnetic powder and rearrangement of particles to obtain a molding of the magnetic powder. The pressure molding includes high-temperature pressure molding in which the mixed powder is pressurized and decompressed at a high elevated temperature equal to or higher than a melting point of the lubricant and equal to or lower than a decomposition temperature of the magnetic powder, and low-temperature pressure molding in which the mixed powder is pressurized and decompressed at a relatively low temperature lower than the melting point of the lubricant.

### INCORPORATION BY REFERENCE

The disclosure of Japanese Patent Application No. 2015-136765 filed on Jul. 8, 2015 including the specification, drawings and abstract, is incorporated herein by reference in its entirety.

### BACKGROUND OF THE INVENTION

1. Field of the Invention

The invention relates to a manufacturing method for a magnet and a magnet.

2. Description of the Related Art

Increasingly high expectations are placed on high-performance magnets that have a high energy product and that exhibit excellent magnetic characteristics. A known typical such magnet is, for example, a magnet containing, as a main component, rare earth metal and intermetallic compound of Co and Fe.

Japanese Patent Application Publication No. 2015-15381 (JP 2015-15381 A) discloses a manufacturing technique for providing a permanent magnet with excellent magnetic characteristics by crushing magnet alloy powder resulting from splat cooling of a molten material containing a combination of rare earth, iron-group metal, and boron such that the resultant powder has a needed particle size, performing cold press to form the powder into a green compact, making the green compact denser by hot or warm press, and further performing hot or warm plastic working to make the green compact magnetically anisotropic. Stress based on hot press described in Japanese Patent No. 2517957 makes a molding anisotropic in a press direction, providing the molding with high magnetic characteristics. This manufacturing method is expected to be based on knowledge that, for example, the magnetic characteristics are further improved by performing upset forging on the molding in the same direction as the press direction.

Japanese Patent Application Publication No. H10-259403 (JP H10-259403 A) discloses a technique for performing, using a mold, compression molding on what is called a bond magnet manufactured by forming a mixture of magnet powder and a bonding resin into a desired magnet shape. The technique is intended to obtain a bond magnet with excellent magnetic characteristics by warm-molding the mixture under pressure using a mold, and then, performing pressure cooling in which the mixture kept under pressure is cooled, to obtain a molding with a low porosity.

However, the manufacturing method in JP 2015-15381 A has an anisotropy mechanism in which a magnetic material of a rare earth element, iron-group metal, and a boron-based element has a composition of Nd2Fe14B and in which Nd2Fe14B crystals enclosed by Nd-rich grain boundary phases grow while being subjected to grain boundary sliding, causing the crystals to be arranged in the same direction to make the molding anisotropic. Making the molding anisotropic using the same method is difficult for an Nd—Fe—B magnet and the like in which no Nd-rich grain boundary phase is present. Japanese Patent No. 3618647 discloses that, when the temperature during hot plastic working is lower than approximately 800° C., the grain boundary sliding and the grain growth of the crystals are unlikely to occur, reducing the degree to which the molding is made anisotropic. In other words, the manufacturing method in JP 2015-15381 A is intended to densify the magnetic material through sintering, while improving the magnetic characteristics of the magnet. The manufacturing method thus needs a high-temperature condition of approximately 800° C., which leads to high manufacturing costs. Besides the high-temperature condition, the method is expected to need a particular applicable magnetic material in connection with the anisotropy mechanism in which the molding is made anisotropic.

The magnet manufactured by the manufacturing method described in JP H10-259403 A is basically a bond magnet, and the bond magnet unavoidably contains a bonding resin. Thus, the magnet has inferior magnetic characteristics to what is called a bulk magnet in which magnet main phases have a density of approximately 100%.

### SUMMARY OF THE INVENTION

An object of the invention is to provide a manufacturing method for a magnet and a magnet in which magnetic characteristics are enhanced by densely arranging magnetic powder containing a magnetic material to increase a residual magnetic flux density.

According to an aspect of the invention, a manufacturing method for a magnet includes performing pressure molding in which mixed powder of magnetic powder and a lubricant is molded under pressure so as to promote cracking of the magnetic powder and rearrangement of particles to obtain a molding of the magnetic powder. The pressure molding includes high-temperature pressure molding in which the mixed powder is pressurized and decompressed at a high elevated temperature equal to or higher than a melting point of the lubricant and equal to or lower than a decomposition temperature of the magnetic powder, and low-temperature pressure molding in which the mixed powder is pressurized and decompressed at a relatively low temperature lower than the melting point of the lubricant.

The above-described manufacturing method for a magnet includes performing the high-temperature pressure molding in which the lubricant exerts an effect. This enables promotion of cracking of the magnetic powder and rearrangement of the particles of the magnetic powder in an internal part of the molding located away, in a pressurization direction, from end surfaces of the molding that are pressurized contact surfaces, while preventing the promotion at the end surfaces. In other words, an uneven density distribution may be obtained in which the density is higher at the end surfaces of the molding and lower in the internal part of the molding.

In contrast, the low-temperature pressure molding is performed to enable promotion of cracking of the magnetic powder and rearrangement of the particles of the magnetic powder at the end surfaces of the molding that are the pressurized contact surfaces. In other words, an uneven density distribution may be obtained in which the density is higher at the end surfaces of the molding and lower in the internal part of the molding.

Therefore, when the pressure molding is performed which includes both the high-temperature pressure molding and the low-temperature pressure molding, the molding has an evenly high density both at the end surfaces of the molding and in the internal part of the molding, located away from the end surfaces along the pressurization direction. This allows the molding as a whole to be made denser. Therefore, a magnet containing the molding has a high residual magnetic flux density, allowing the magnetic characteristics to be enhanced. This contributes to a reduction in the size of magnet built-in equipment and an increase in output from the magnet built-in equipment.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a chart illustrating steps of a manufacturing method for a magnet in an embodiment;

FIG. 2A is a schematic diagram depicting an initial state of a step of manufacturing mixed powder in FIG. 1;

FIG. 2B is a schematic diagram depicting an end state of the step of manufacturing mixed powder in FIG. 1;

FIG. 3 is a sectional view schematically depicting mixture of magnetic powder and a binder in the embodiment;

FIG. 4A is a schematic diagram depicting an initial state of a pressure molding step in FIG. 1;

FIG. 4B is a schematic diagram depicting an initial state of a high-temperature pressure molding step in FIG. 1;

FIG. 4C is a schematic diagram depicting an end state of the high-temperature pressure molding step in FIG. 1;

FIG. 4D is a schematic diagram illustrating that the pressure molding step in FIG. 1 is about to end;

FIG. 5 is an enlarged diagram schematically depicting an arrangement state of particles of magnetic powder in a molding in the embodiment;

FIG. 6 is an enlarged diagram schematically depicting a configuration of a magnet in the embodiment;

FIG. 7 is a diagram schematically depicting a variation in temperature in the pressure molding step in FIG. 1;

FIG. 8 is a partial sectional view of a molding illustrating a density distribution;

FIG. 9 is views of photographs of enlarged sections of the molding, illustrating the density distribution;

FIG. 10 is a graph illustrating a density ratio for the molding in the embodiment; and

FIG. 11 is a graph illustrating the density ratio for the moldings at end surfaces thereof and in an internal part thereof.

### DETAILED DESCRIPTION OF EMBODIMENTS

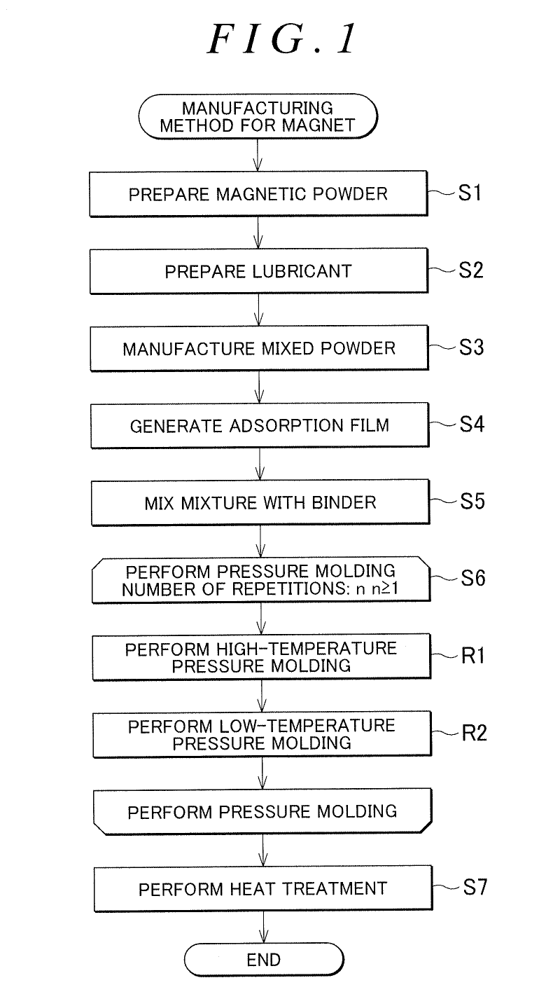

A manufacturing method for a magnet in the invention will be specifically described as an embodiment with reference to FIGS. 1 to 10. FIG. 1 is a chart illustrating steps of the manufacturing method for a magnet in the present embodiment.

As illustrated in step S1 in FIG. 1, magnetic powder 11 is prepared as a material for a magnet.

The magnetic powder 11 is powder that is an aggregate of particles of a magnetic material. The magnetic material for the magnetic powder 11 is not limited but is preferably a hard magnetic substance. Examples of the hard magnetic substance include a ferrite magnet, an Al—Ni—Co-based magnet, a rare earth magnet containing rare earth elements, and an iron nitride magnet.

As the magnetic powder 11 for the hard magnetic substance, a compound containing one or more of Fe—N-based compounds and R—Fe—N-based compounds (R: rare earth elements) is preferably used. The rare earth elements represented as R may be elements known as what is called rare earth elements (Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr) and are preferably rare earth elements other than Dy (R: rare earth elements other than Dy). Among these rare earth elements, light rare earth elements are particularly preferable. Among the light rare earth elements, Sm is most suitable. The light rare earth elements as used herein are elements included in lanthanoids and having a smaller atomic weight than Gd, that is, La to Eu. The Fe—N-based compound is contained in an iron nitride magnet. The R—Fe—N-based compound is contained in a rare earth magnet.

A specific composition of the magnetic powder 11 is not limited as long as the magnetic powder 11 contains the Fe—N-based compound or the R—Fe—N-based compound. The magnetic powder 11 is most preferably powder of Sm₂Fe₁₇N₃ or Fe₁₆N₂.

The particle size (average particle size) of the magnetic powder 11 is not limited. The average particle size (D50) is preferably approximately 2 to 5 μm. In the magnetic powder 11 used, an oxide film is not formed all over the surfaces of particles. The D50 as used herein means that the particles have a cumulative frequency of approximately 50 mass % in a particle size distribution.

As illustrated in step S2 in FIG. 1, a lubricant 21 is prepared. The lubricant 21 that is a solid substance (solid lubricant) under normal conditions (in an air atmosphere and at room temperature) is preferably used. As the lubricant 21, a powdery lubricant is used.

As the lubricant 21, a metal soap-based lubricant (solid lubricant powder) is used. The lubricant 21 is, for example, powder of stearic acid-based metal such as zinc stearate. The powder of the lubricant 21 has an average particle size (D50) of approximately 10 μm. The lubricant 21 preferably has a larger average particle size than the magnetic powder 11. The lubricant 21 has a smaller specific gravity than the magnetic powder 11. Consequently, when the lubricant 21 has a somewhat large size in an initial state, each particle of the lubricant 21 may have a large mass, allowing the lubricant 21 to be precluded from scattering around during mixture in step S3 described below.

A mixing ratio between the magnetic powder 11 and the lubricant 21 may be optionally set. For the mixing ratio between the magnetic powder 11 and the lubricant 21, preferably, the mixed powder contains 80 to 90 vol % magnetic powder 11 and 5 to 15 vol % lubricant 21. Besides the magnetic powder 11 and the lubricant 21, an additive may be contained. Examples of the additive may include organic solvents that may be lost on subsequent heating.

As illustrated in step S3 in FIG. 1, the magnetic powder 11 and the lubricant 21 prepared in the above-described two steps are mixed together into mixed powder.

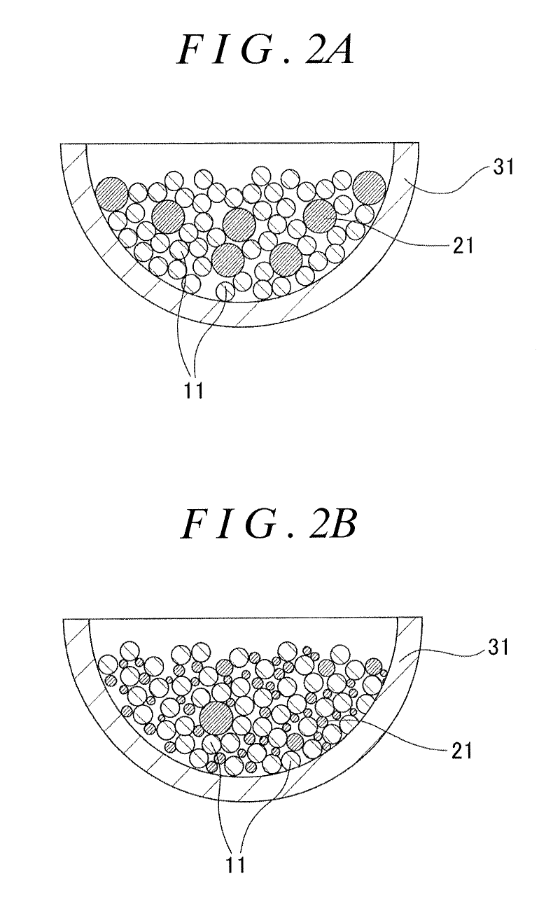

The magnetic powder 11 and the lubricant 21 are mixed together while being ground. A method for forming the mixed powder involves mixing the magnetic powder 11 and the lubricant 21 together while the magnetic powder 11 and the lubricant 21 are ground in a mixing container 31, as depicted in FIG. 2A. When the magnetic powder 11 and the lubricant 21 are mixed together while being ground, the lubricant 21, which has a low binding strength, is fractionized to reduce the particle size of the lubricant 21 as a whole, as depicted in FIG. 2B. At the end of step S3, particles of the lubricant 21 with different sizes are present.

Formation of the mixed powder 11, 21 reduces aggregated portions containing only the magnetic powder 11 (disintegrates secondary particles of the magnetic powder 11), and reduces the size of the lubricant 21. In other words, particles of the lubricant 21 resulting from fractionization can be placed in proximity to the particles of the magnetic powder 11.

Next, as illustrated in step S4 in FIG. 1, the mixed powder 11, 21 is heated to form an adsorption film 22 on the surface of the magnetic powder 11.

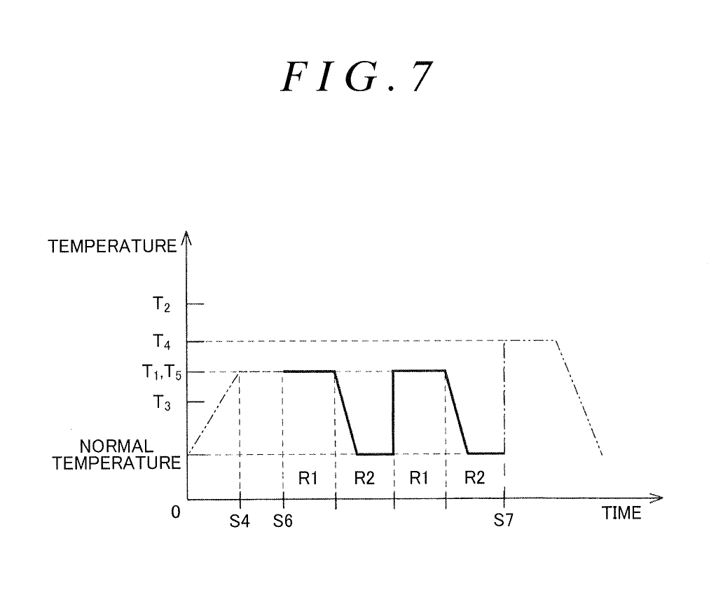

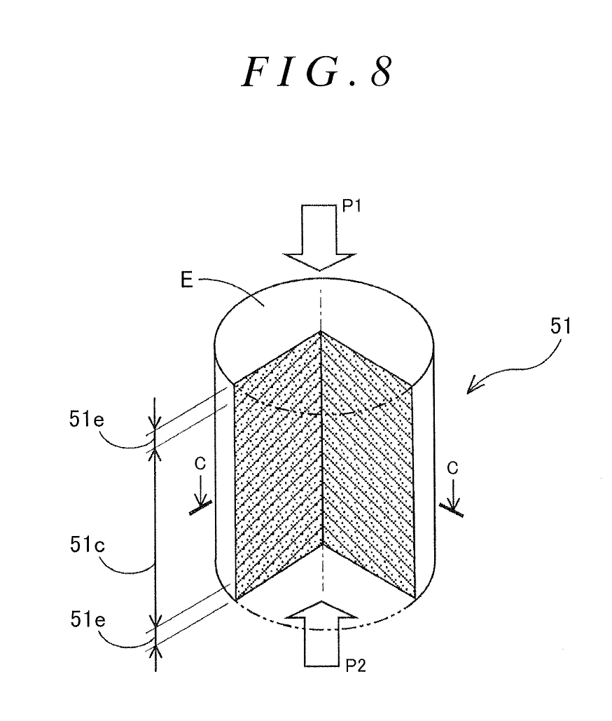

The mixed powder 11, 21 resulting from the mixture of the magnetic powder 11 and the lubricant 21 in the above-described step (step S3) is heated at a heating temperature T1 to form the adsorption film 22 of the lubricant 21 on the surface of the magnetic powder 11. At this time, the heating temperature T1 for the mixed powder 11, 21 is lower than a decomposition temperature T2 of the magnetic powder 11 and is equal to or higher than a melting point T3 of the lubricant 21 (T3<T1<T2, see FIG. 7).

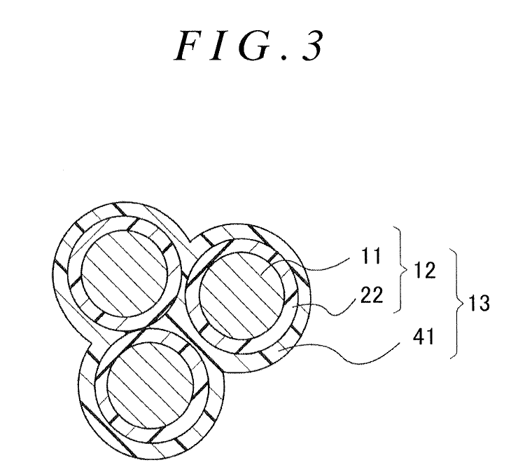

Heating the mixed powder 11, 21 at the heating temperature T1 causes the lubricant 21 to be melted without decomposition of the magnetic powder 11. The melted lubricant 21 flows along the surfaces of the particles of the magnetic powder 11 to coat the surface of the magnetic powder 11. The adsorption film 22 is then formed on the surface of the magnetic powder 11. The adsorption film 22 may be formed as a layer obtained by chemically bonding a soap component of the lubricant to the surface of the magnetic powder 11 or may be formed as a layer only of the lubricant on the surface of the magnetic powder 11. For the adsorption film 22 in the form of a layer, the mixed powder 11, 21 is cooled to a temperature lower than the melting point T3 after the adsorption film 22 is formed. The adsorption film 22 is thus solidified and fixed so as not to detach from the surface of the magnetic powder 11. The magnetic powder 11 with the adsorption film 22 formed thereon is hereinafter also referred to as a coated magnetic powder denoted by reference numeral 12 (see FIG. 3).

A heating time at the heating temperature T1 depends on the amount of heat applied to the mixed powder 11, 21 and is not limited. In other words, the amount of heat applied to the mixed powder 11, 21 per unit time increases consistently with heating temperature T1, and thus the heating time can be reduced. When the heating temperature T1 is relatively low, the heating time is preferably extended.

In connection with the heating temperature T1 and the heating time, an increase in the amount of heat applied to the mixed powder 11, 21 allows the adsorption film 22 to be more aggregately generated on the surface of the magnetic powder 11. This prevents the film from being broken during a pressure molding step (step S6). This enables, particularly in high-temperature pressure molding in step R1 described below, a reduction in friction between particles of the magnetic powder 11 contained in the internal part of the molding, contributing to transmission of an applied pressure to the internal part of the molding.

Subsequently, as illustrated in step S5 in FIG. 1, an uncured binder 41 that is formed of, for example, a silicone composition is placed on the surface of the coated magnetic powder 12. The binder 41 is gelled or liquid at room temperature and is fluid. Mixing the coated magnetic powder 12 with the binder 41 allows the binder 41 to be placed on the surfaces of the particles of the coated magnetic powder 12. In this state, as depicted in a schematic sectional view in FIG. 3, the binder 41 is interposed between the adjacent particles of the coated magnetic powder 12. The coated magnetic powder 12 with the binder 41 interposed between the adjacent particles of the coated magnetic powder 12 is hereinafter also referred to as processed magnetic powder denoted by reference numeral 13 (see FIG. 3).

As the silicone composition in the binder 41, a composition is used which has a main framework based on siloxane bonding. More specifically, s silicone resin is used as the silicone composition. The silicone composition is uncured (gelled or liquid) when placed on the surface of the coated magnetic powder 12 and is cured during a later step (in the present embodiment, during thermal curing in step S7).

The thermosetting silicone composition has a curing temperature (curing start temperature) T4 that is lower than the decomposition temperature T2 of the magnetic powder 11. As described below, the curing temperature (curing start temperature) T4 is set higher than a high temperature during the high-temperature pressure molding in step R1 so as to prevent the binder 41 from being prematurely cured in the middle of the high-temperature pressure molding in step R1. Alternatively, a composition is preferably used which can be adjusted to start to be cured at a high temperature higher than the high temperature during the high-temperature pressure molding step, by using a predetermined compound as a curing initiator in the silicone composition.

The mixture rate of the binder 41 may be optionally set. For example, when the volume of the coated magnetic powder 12 (with the adsorption film 22 formed thereon) is defined to be 100 vol %, the mixed powder preferably contains 5 to 15 vol % binder 41 and more preferably 8 to 12 vol % binder 41. A method for curing the binder 41 is not limited. For example, the method may involve starting the curing by heating, irradiation with ultraviolet rays, or contact with a reaction initiator such as water.

Subsequently, as illustrated in step S6 in FIG. 1, the pressure molding step is executed in which the magnetic powder is pressurized to form a molding. The inventors performed uniaxial pressure molding on magnetic powder contained in a mold. The inventors then noted that the density of the resultant molding varies with an area of the molding, that is, an area of the molding varies where clearances between the particles of the magnetic powder are likely to be reduced by promoted cracking and rearrangement of the magnetic powder, depending on whether the pressure molding is performed at a high elevated temperature or at normal temperature, which is lower than the high temperature. The inventors thus found that a molding generally having an evenly high density can be obtained by performing both the high-temperature pressure molding at the high temperature and the low-temperature pressure molding at normal temperature. The manufacturing method for a magnet in the present embodiment is characterized in that the pressure molding in step S6 illustrated in FIG. 1 includes high-temperature pressure molding in step R1 in which the magnetic powder is pressurized and decompressed at a high elevated temperature T5 equal to or higher than the melting point T3 of the lubricant 21 and equal to or lower than the decomposition temperature T2 of the magnetic powder 11 and low-temperature pressure molding in step R2 in which the magnetic powder is pressurized and decompressed at a temperature lower than the melting point T3 of the lubricant 21 and relatively lower than the high temperature T5. The manufacturing method will be described below.

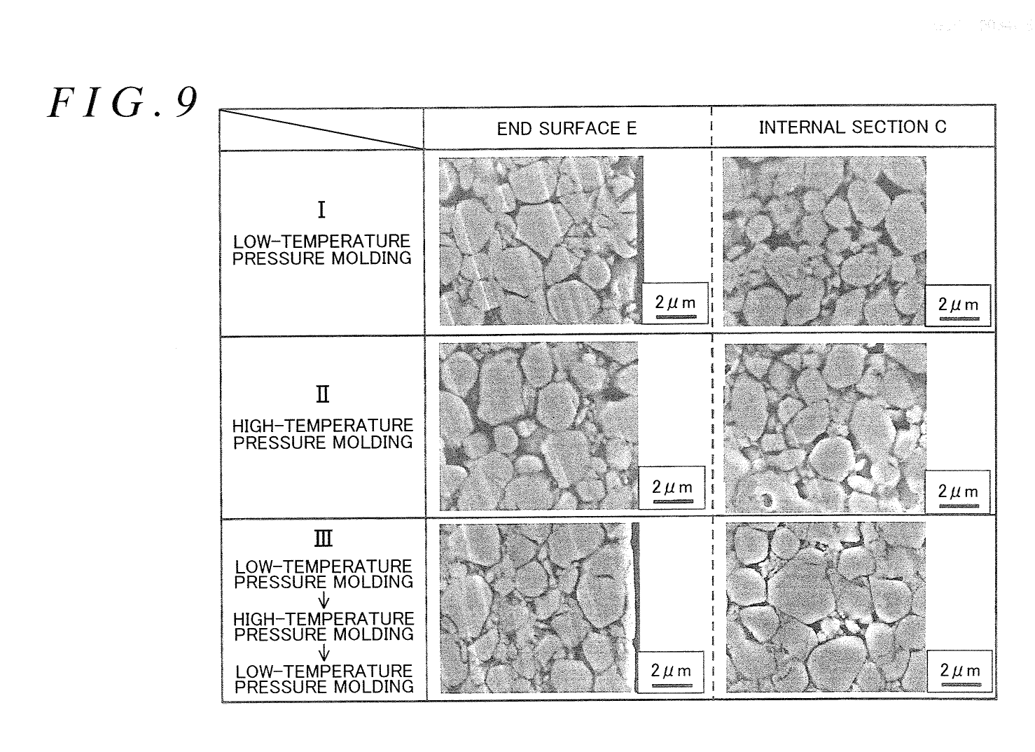

First, the above-described noted point, which is a premise of the pressure molding step in the present embodiment, will be described using electron microscope photographs of an end surface E and an internal section C of a molding 51 depicted in FIG. 8. A mold with a column-shaped cavity was filled with the mixed powder 11, 21, and uniaxial pressure molding was performed on the mixed powder 11, 21. As depicted in FIG. 8, the mixed powder 11, 21 contained in the mold were pressurized and decompressed at the end surface E of the mixed powder in both a downward direction P1 and an upward direction P2 using an upper punch and a lower punch (not depicted in the drawings) to obtain the column-shaped molding 51. Pressure molding conditions were such that a pressure (molding surface pressure) of 1400 MPa was applied and that punching was performed 60 times. II in FIG. 9 depicts a photograph of the end surface E of the molding 51 subjected to high-temperature pressure molding at a high temperature of 130° C. and a photograph of the internal section C of a substantially central portion of the molding 51 in the axial direction.

As depicted in II, in the molding subjected to the high-temperature pressure molding, rearrangement of the particles of the magnetic powder exposed in the internal section C was appropriately promoted. Thus, the particles in the internal section C had reduced clearances therebetween and were densely packed. On the other hand, larger clearances remained between the particles of the magnetic powder at the end surface E than in the internal section C. Although not depicted in the drawings, when other photographs of internal sections were also checked which were taken at predetermined intervals along the axial direction, the state where the particles forming the magnetic powder were densely packed was observed in the whole internal part of the molding 51 along the axial direction denoted by reference numeral 51c in FIG. 8 but not observed in areas of the molding near the end surfaces denoted by reference numeral 51e in FIG. 8.

I in FIG. 9 depicts a photograph of the end surface E of the molding 51 subjected to low-temperature pressure molding at normal temperature and a photograph of the internal section C of the substantially central portion of the molding 51 in the axial direction. The low-temperature pressure molding was performed at the same conditions except that the temperature during molding was set to the normal temperature.

As depicted in I, in the molding subjected to the low-temperature pressure molding, rearrangement of the particles of the magnetic powder at the end surface E was appropriately promoted. Thus, the particles at the end surface E had reduced clearances therebetween and were densely packed. On the other hand, larger clearances remained between the particles of the magnetic powder exposed in the internal section C as compared the clearances between the particles at the end surface E. In other words, the area where the particles of the magnetic powder were densely packed varied between the high-temperature pressure molding and the low-temperature pressure molding. The low-temperature pressure molding was determined to involve a density distribution in which the particles are densely located, in a biased manner, near the end surfaces denoted by reference numeral 51e, and the particles in most of the internal part of the molding 51 denoted by reference numeral 51c have larger clearances therebetween than the particles near the end surfaces.

A temperature condition under which the lubricant acts more appropriately is expected to be the reason why, in the high-temperature pressure molding in II in FIG. 9, the particles of the magnetic powder in the internal part of the molding have reduced clearances and are densely packed but the particles of the magnetic powder at the end surfaces (the surfaces with which the punch comes into contact) are not densely packed, resulting in an uneven density distribution of the molding as a whole. The effect of the lubricant reduces friction between the particles of the magnetic powder forming the molding and friction between the magnetic powder and an inner wall surface of the mold. This allows the pressure applied by the punches to be easily transmitted even to the internal part of the molding and to act more significantly. This promotes sinking or sticking movement, in other words, rearrangement, of the particles of the magnetic powder toward the internal part of the molding, located away from the surfaces of the molding with which the punches come into contact. Therefore, the particles of the magnetic powder are likely to be densely packed in the internal part of the molding. In other words, the pressure applied by the punches is relatively unlikely to be transmitted through the surfaces of the molding with which the punches come into contact, hindering rearrangement of the particles of the magnetic powder at the end surfaces. Therefore, near the end surfaces of the molding, clearances remain between the particles of the magnetic powder, making the particles unlikely to be densely packed. As a result, the density distribution of the molding as a whole varies depending on the area of the molding.

The high temperature during the high-temperature pressure molding may be any high temperature at which the lubricant exerts an effect thereof so as to induce the rearrangement of the particles of the magnetic powder. In the specification, the lower limit of the high temperature is defined to be equal to or higher than the melting point of the lubricant in order to clarify the invention.

The upper limit of the high temperature is defined to be equal to or higher than the decomposition temperature of the magnetic powder. By way of example, when the magnetic powder is a compound containing one or more of Fe—N-based compounds and R—Fe—N-based compounds (R: rare earth elements), measure of the decomposition temperature is approximately 500° C. In actuality, in a magnetic material containing this compound as a main component, a metal oxide is generated in a high-temperature oxygen atmosphere to degrade the magnetic characteristics. To avoid this, the upper limit of the high temperature may be set to approximately 160° C. The high temperature is also lower than a temperature at which the lubricant is, for example, carbonized and precluded from exerting a lubrication effect. When the lubricant is, for example, powder of stearic acid-based metal such as zinc stearate, the upper limit temperature at which the lubrication effect is exerted is expected to be approximately 350 to 450° C.

The low-temperature pressure molding in I in FIG. 9 involves the relatively low temperature, which prevents adequate exertion of the lubrication effect, which induces sliding and movement (rearrangement) of the particles of the magnetic powder. This is expected to be the reason why the particles of the magnetic powder are densely packed at the end surfaces (the surfaces with which the punches come into contact) in a biased manner, making the density distribution of the molding as a whole uneven. Therefore, sliding and movement (rearrangement) of the particles of the magnetic powder in the internal part of the molding are not promoted, and the applied pressure is likely to be concentrated in the vicinities of the surfaces with which the punches come into contact. In other words, the distribution, in the interior of the molding, of the pressure applied by the punches is uneven such that the pressure is high mostly at the end surfaces. As a result, the density distribution of the molding as a whole exhibits a high density at the end surfaces and is uneven.

The low temperature during the low-temperature pressure molding is not particularly limited as long as the low temperature prevents adequate exertion of the lubrication effect, which induces the above-described sliding and movement (rearrangement) of the particles of the magnetic powder. In the specification, the low temperature is defined to be lower than the melting point of the lubricant and relatively lower than the high temperature in order to clarify the invention. By definition, even a temperature falling outside the range of low temperatures based on common knowledge, such as 100° C. or higher, such a temeperature may be used as the low temperature as long as the temperature is lower than the melting point of the lubricant, relatively lower than the high temperature, and prevents the lubricant from adequately exerting the effect thereof. An example of the low temperature is the normal temperature, at which no special heating operation is needed during the pressure molding. As described above, the low temperature is not limited to the normal temperature as long as the low temperature is lower than the melting point of the lubricant, relatively lower than the high temperature, and allows pressure molding to be achieved according to technically common knowledge. For example, the low temperature may be equal to or lower than 0° C.

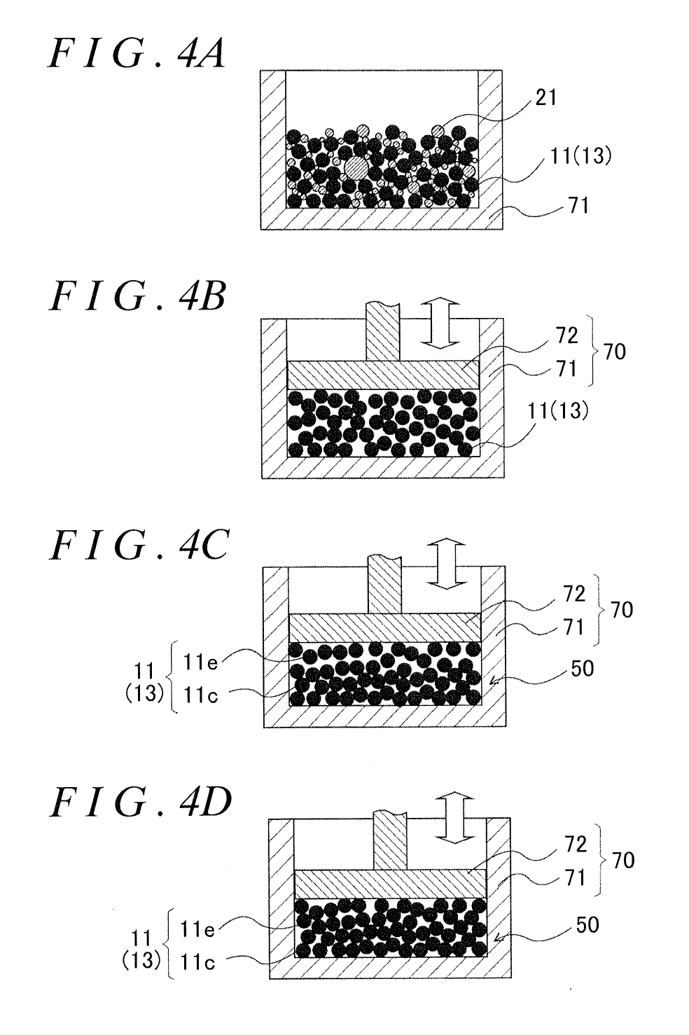

In the pressure molding step, the processed magnetic powder 13 is placed in the cavity of a pressurizing mold 70 (pressurizing lower mold 71) as depicted in a schematic diagram in FIG. 4A. The pressurizing mold 70 is made from a nonmagnetic hard metal alloy. The pressure molding step is executed under the condition that lines of magnetic force are transmitted through the processed magnetic powder 13 (the condition for magnetic field orientation). To facilitate understanding of a process in which the particles of the magnetic powder 11 are rearranged by pressurization and decompression, FIGS. 4A to 4D schematically depict, as filled circles, the processed magnetic powder 13 with the adsorption film 22 formed thereon and with the binder 41 placed thereon.

Subsequently, as depicted in a schematic diagram in FIG. 4B, the pressurizing lower mold 71 and a pressurizing upper mold 72 are assembled together and moved in respective directions in which the pressurizing lower mold 71 and the pressurizing upper mold 72 approach each other. Thus, the pressurizing mold 70 (71, 72) is used to mold the processed magnetic powder 13 through pressurization and decompression. In the present embodiment, the high-temperature pressure molding is initially performed as illustrated in step R1 in FIG. 1. In the high-temperature pressure molding step, the pressurizing mold 70 (71, 72) is heated to heat the processed magnetic powder 13 in the pressurizing mold 70 (71, 72). Specifically, a heater and a temperature sensor (not depicted in the drawings) are attached to an outer side surface of the pressurizing mold 70. A temperature regulator (depicted in the drawings) is provided outside the pressurizing mold 70. A set temperature is set in the temperature regulator, and a current passed through the heater is controlled with signals from the temperature sensor checked so that the pressurizing mold 70 is controlled to the set temperature. At this time, the high temperature T5 of the magnetic powder 11 is equal to or higher than the melting point T3 of the lubricant 21 (T3≦T5, see FIG. 7). For example, the high temperature T5 may be set equivalent to the heating temperature T1 for the mixed powder 11, 21 of the magnetic powder 11 and the lubricant 21 described in the generation of the adsorption film in step S4.

The high temperature T5 is also lower than the curing temperature T4 of the binder 41 and also lower than the decomposition temperature T2 of the magnetic powder 11 (T5<T4<T2, see FIG. 7). Therefore, even on heating, the magnetic powder 11 is not decomposed, and the binder 41 is not cured. The heating method for the high-temperature pressure molding is not limited to heating of the pressurizing mold 70. A predetermined method may be used to warm the processed magnetic powder 13 itself or both the pressurizing mold 70 and the processed magnetic powder 13. Heating the pressurizing mold 70 allows the processed magnetic powder 13 to be also heated by heat conduction. Heating both the pressurizing mold 70 and the processed magnetic powder 13 increases production efficiency.

Specifically, when the lubricant 21 is, for example, zinc stearate, the high temperature T5 for the high-temperature pressure molding may be equal to or higher than the melting point of zinc stearate, that is, the high temperature T5 may be 130 to 150° C. In this case, the curing temperature T4 of the silicone composition that is the binder 41 described below may be adjusted to 150 to 160° C. When the lubricant 21 is, for example, a stearic acid, the high temperature T5 may be set equal to or higher than the melting point of the stearic acid, that is, the high temperature T5 may be set to 60 to 70° C. As described above, the high temperature depends on the temperature at which the lubricant exerts the effect thereof and may thus vary according to the lubricant used.

The pressure applied by the pressurizing mold 70 (71, 72) during the high-temperature pressure molding is equal to or lower than the burst pressure at which the magnetic powder 11 is destroyed. In the present embodiment, the applied pressure is equal to or lower than 1.4 GPa. The operation of pressurization and decomposition using the pressurizing mold 70 (71, 72) is performed a plurality of times. After a pressure is applied to the pressurizing upper mold 72, the pressure applied to the pressurizing upper mold 72 is reduced for decompression, and a pressure is applied to the pressurizing upper mold 72 again. The operation of pressurization and decompression is repeated. To release the pressure applied to the pressurizing upper mold 72, the pressurizing upper mold 72 may be moved upward or only the pressure applied to the pressurizing upper mold 72 may be reduced without upward movement of the pressurizing upper mold 72.

The pressurizing and decompressing operations using the pressurizing mold 70 (71, 72) may be repeated until the density of a molding 50 plateaus. For example, the number of pressurizing operations may be 2 to 30. Preferably, the pressurization and decompression may be performed by consecutively punching the magnetic powder approximately 10 to 20 times using the punches. Repeating the pressurization and decomposition using the pressurizing mold 70 allows the rearrangement of the particles of the magnetic powder 11 from the arrangement of the particles of the magnetic powder 11 resulting from the last pressurization. The clearances between the particles of the magnetic powder 11 (processed magnetic powder 13) are thus reduced.

During the rearrangement of the particles of the magnetic powder 11, the particles of the magnetic powder 11 (coated magnetic powder 12) move very smoothly because the adsorption film 22 of the lubricant 21 is interposed between contact surfaces of the adjacent particles of the magnetic powder 11. The clearances between the particles of the magnetic powder 11 in the molding 50 are reduced in size by a synergistic effect of the rearrangement of the particles of the magnetic powder 11 and sliding attributed to the adsorption film 22.

The uncured binder 41 is also interposed between the particles of the magnetic powder 11 (coated magnetic powder 12). The uncured binder 41 exhibits the characteristics of silicone oil and also exhibits lubricity. In other words, movement (rearrangement) of the particles of the magnetic powder 11 is promoted by the interposition of the adsorption film 22 and the uncured binder 41 between the adjacent particles of the magnetic powder 11. This action also serves to reduce the clearances between the particles of the magnetic powder 11 in the molding 50. That is, as depicted in FIG. 4C, the molding 50 is obtained which has reduced clearances between the particles of the magnetic powder 11. At this time, a number of large clearances remain between the particles of magnetic powder 11 e at the end surfaces of the molding 50, located near the punches, as described above. In contrast to the particles of magnetic powder 11 e at the end surfaces, the particles of magnetic powder 11c in the internal part of the molding 50 have reduced clearances between the particles and are densely packed. Since the pressure applied by the punches acts more significantly in the internal part of the molding 50 that is located away from the end surfaces, the clearances between the particles of the magnetic powder 11c are reduced, whereas larger clearances remain between the particles of the magnetic powder 11e. Consequently, the molding 50 has an uneven density distribution.

Now, as illustrated in step R2 in FIG. 1, the low-temperature pressure molding is performed. The low-temperature pressure molding may be performed in the same manner as the high-temperature pressure molding except that the temperature condition for the pressure molding is changed. A method for arranging a low-temperature environment is not particularly limited. For example, the low-temperature pressure molding may be performed during the period after the heating by the heater for the high-temperature pressure molding described above is stopped so that the mold is left uncontrolled to lower the mold temperature until the mold temperature reaches the normal temperature and while the mold temperature is maintained at the normal temperature (see R2 in FIG. 7). Alternatively, the low-temperature pressure molding may be performed after the temperature of the mold is cooled as low as the normal temperature or the mold may be rapidly cooled using a predetermined cooling apparatus. Specifically, a channel is formed inside the pressurizing mold 70, and piping and a temperature sensor are mounted in the channel (not depicted in the drawings). A cooling apparatus with a temperature regulator is provided outside the pressurizing mold 70 (not depicted in the drawings). A set temperature is set in the temperature regulator, and the temperature of a fluid fed from the cooling apparatus is controlled with signals from the temperature sensor checked. The pressurizing mold 70 is thus controlled to the set temperature.

For the low-temperature pressure molding, for example, the pressurizing operation can be performed by applying a pressure to the pressurizing upper mold 72, then reducing the pressure applied to the pressurizing upper mold 72 for decompression, applying a pressure to the pressurizing upper mold 72 again, and repeating this operation, as is the case with the high temperature molding. Preferably, the pressurization and decompression may be performed by consecutively punching the magnetic powder approximately 10 to 20 times using the punches. When a transition is made from the high-temperature pressure molding to the low-temperature pressure molding, the applied pressure may be temporarily reduced after the high-temperature pressure molding and then the low-temperature pressure molding step may be executed. However, an aspect is not excluded in which the low-temperature pressure molding step is executed with the pressure applied for the high-temperature pressure molding maintained.

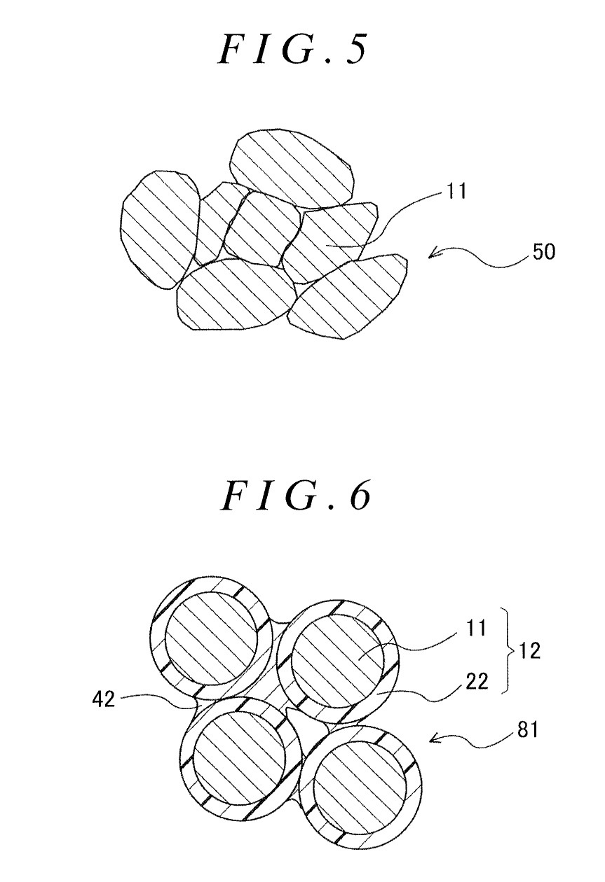

The low-temperature pressure molding results in a dense molding 50 in which all the particles of the magnetic powder 11 have reduced clearances between the particles as depicted in a schematic diagram in FIG. 4D. In other words, for both the cluster of particles of the magnetic powder 11e at the end surfaces of the molding 50 and the cluster of particles of the magnetic powder 11c in the internal part of the molding 50, clearances between the particles are small and the particles are densely packed, so that the density distribution of the molding 50 as a whole is even. The particles of the magnetic powder 11 as depicted in an enlarged view in FIG. 5 are brought into pressure contact with one another and closely bonded together to form a molding 50. This is because the low-temperature pressure molding allows the pressure added by the punches to act on the end surfaces of the molding 50 in a concentrative manner to move the particles of the magnetic powder 11e, somewhat coarsely arranged at the end surfaces during the high-temperature pressure molding, such that the clearances between the particles are reduced in size. The particles are thus rearranged and densely packed.

The pressure molding step in the present embodiment is a molding method involving repeatedly executing the high-temperature pressure molding step and the low-temperature pressure molding step described above. The order in which the high-temperature pressure molding step and the low-temperature pressure molding step are executed is not particularly limited. The pressure molding may be performed, for example, in an order of high temperature (pressure molding), low temperature (pressure molding), high temperature, and low temperature or in an order of low temperature, high temperature, and low temperature. The pressure molding step executed first is preferably the high-temperature pressure molding step, and the pressure molding step executed last is preferably the low-temperature pressure molding step. In the pressure molding in step S6 illustrated in FIG. 1, a cycle of the high-temperature pressure molding and the low-temperature pressure molding (R1 and R2), in which the high-temperature pressure molding in step R1 is firstly performed and then the low-temperature pressure molding in step R2 is performed, is repeated n times. FIG. 7 illustrates, by a thick continuous line, a variation in temperature observed when the pressure molding was performed in an order of high temperature, low temperature, high temperature, and low temperature. However, the present embodiment is not limited to the illustration in FIG. 7.

The number of repetitions is such that the high-temperature pressure molding may be performed at least once and that the low-temperature pressure molding may be performed at least once. For example, a method may be used which involves performing the high-temperature pressure molding, and after a predetermined conditioning period, performing the high-temperature pressure molding again, and then performing the low-temperature pressure molding, and repeating this cycle (high temperature, high temperature, and low temperature). However, it is preferable that the high-temperature pressure molding and the low-temperature pressure molding be alternately performed. In a preferred embodiment of the pressure molding step, the high-temperature pressure molding is firstly performed which involves consecutively punching the magnetic powder approximately 10 times using the punches, and then the low-temperature pressure molding is performed which similarly involves consecutively punching the magnetic powder approximately 10 times using the punches.

The pressure molding was performed in an order of low temperature, high temperature, and low temperature under the same conditions as those in I in FIG. 9 and II in FIG. 9 to obtain a column-shaped molding 51 depicted in FIG. 8. An electron microscope was used to take photographs of the end surface E of the molding 51 and the internal section C of a substantially central portion of the molding 51 in the axial direction. III in FIG. 9 depicts the photographs. The number of punching operations for the pressure molding was 20 for the low-temperature pressure molding, 20 for the high-temperature pressure molding, and 20 for the low-temperature pressure molding; the total number of punching operations was 60. For the transition from the low temperature to the high temperature and the transition from the high temperature to the low temperature (high temperature: 130° C., low temperature: normal temperature), the temperature was controlled, and the pressure molding was performed under the condition that a predetermined constant temperature was maintained.

III in FIG. III indicates that, in the molding 51 subjected to the high-temperature pressure molding and the low-temperature pressure molding, the particles of the magnetic powder have reduced clearances between the particles and are densely packed both in the internal section C and at the end surface E. The state where the particles forming the magnetic powder were densely packed was observed in the whole internal part of the molding 51 along the axial direction denoted by reference numeral 51c in FIG. 8.

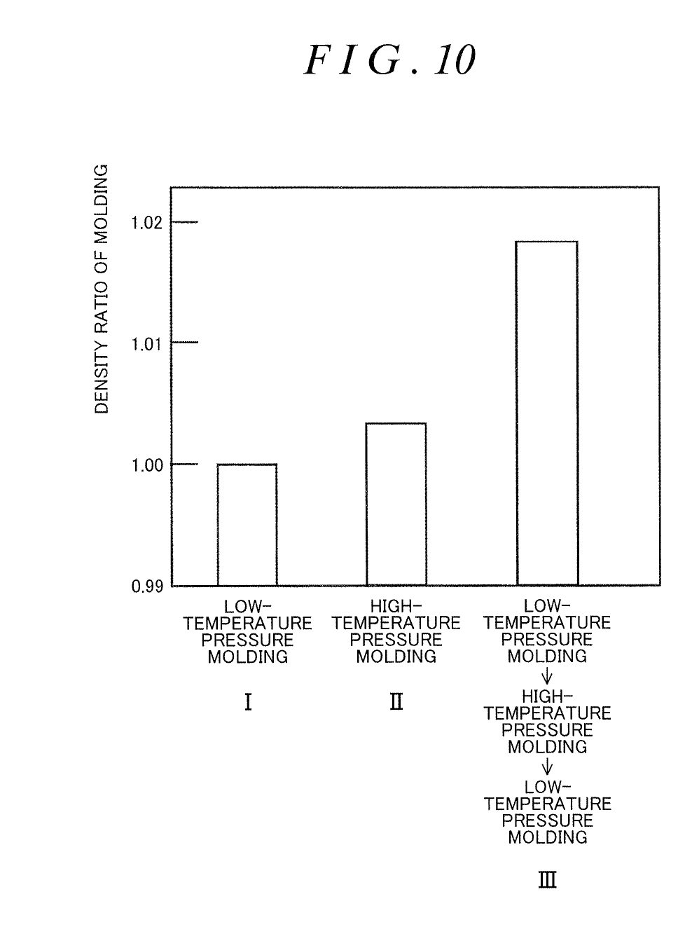

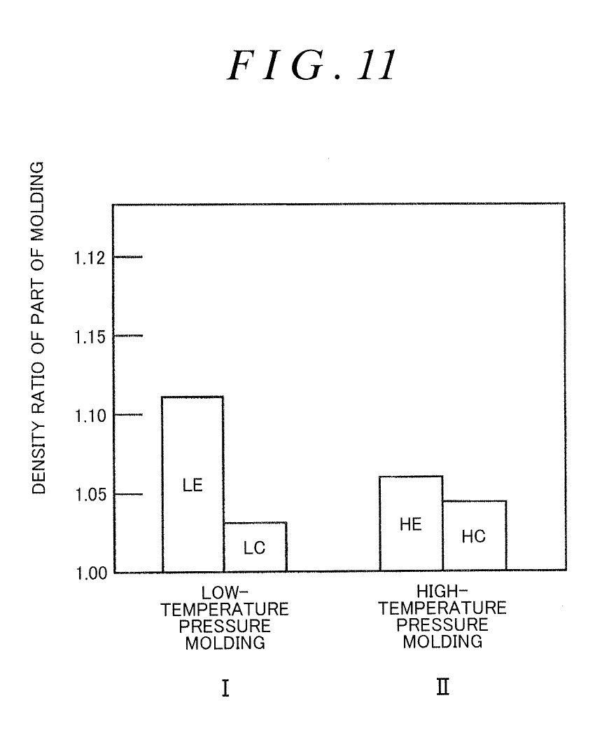

FIG. 10 is a graph illustrating the ratio of the density (g/cm³) of a molding subjected only to the high-temperature pressure molding (corresponding to the condition II in FIG. 9) to the density of a molding subjected only to the low-temperature pressure molding (corresponding to the condition I in FIG. 9), the density of which is defined to be a reference value of 1, and the ratio of the density of a molding subjected to the pressure molding in an order of low temperature, high temperature, and low temperature (corresponding to the condition III in FIG. 9) to the density of the molding subjected only to the low-temperature pressure molding (reference value).

As depicted in FIG. 10, the molding in II subjected only to the high-temperature pressure molding has a higher density than the molding in I subjected only to the low-temperature pressure molding has (approximately 1.013 times). This is expected to be because, compared to the low-temperature pressure molding, the high-temperature pressure molding effectively reduces the clearances between the particles of the magnetic powder in most of the volume of the molding. The molding in III subjected to the pressure molding in an order of low temperature, high temperature, and low temperature has further higher density than the molding in I (approximately 1.018 times). When the density of the molding was converted into the volume of the magnet, the effect of such an increase in density was determined to be equivalent to approximately 10% increase in volume. This is a very excellent result.

In FIG. 11, the density (g/cm³) of a molding subjected only to the low-temperature pressure molding is defined to be a reference value of 1. The left of the graph in FIG. 11 shows the ratio LE of the density between the molding and a part of the molding subjected only to the low-temperature pressure molding (corresponding to the condition I in FIG. 9) which relates to the end surface E, and the ratio LC of the density between the molding and a part of the molding subjected only to the low-temperature pressure molding which relates to the internal section C. Similarly, the right of the graph shows the ratio HE of the density between the molding and a part of a molding subjected only to the high-temperature pressure molding (corresponds to the condition II in FIG. 9) which relates to the end surface E, and the ratio HC of the density between the molding and a part of the molding subjected to only the high-temperature pressure molding which relates to the internal section C. As depicted in FIG. 11, for the molding in I subjected only to the low-temperature pressure molding, LE is significantly higher than LC. Therefore, the particles of the magnetic powder near the end surface E are expected to have reduced clearances between the particles and to be densely packed, whereas relatively large clearances are expected to remain between the particles of the magnetic powder in the internal part of the molding located away from the end surface E. Thus, the molding as a whole is expected to be in an uneven state where the density is excessively high near the end surface E. FIG. 11 indicates that, for the molding in II subjected only to the high-temperature pressure molding, HE is higher than HC but the difference between HE and HC is smaller than that between LE and LC. Therefore, although the density is high near the end surface E as is the case with the molding in I, the unevenness of the density of the molding as a whole, that is, the variation in density between the internal part of the molding and the vicinities of the end surface E is expected to be reduced. The density ratio between the parts of the molding was determined based on the rate of the area of the clearance part or the particle part in the electron microscope photographs depicted in I in FIG. 9 and II in FIG. 9 and binarized in terms of the clearance part or the particle part.

A comparison of I with II indicates that LE is higher than HE and that HC is higher than LC. Therefore, the low-temperature pressure molding is likely to increase the density near the end surface E of the molding, and the high-temperature pressure molding is likely to increase the density in the internal part of the molding.

When the pressure molding is performed in an order of the low-temperature pressure molding and the high-temperature pressure molding, the clearances between the particles of the magnetic powder at the end surfaces of the molding are initially significantly reduced (see LE). In other words, near the end surfaces, the significantly packed particles of the magnetic powder are formed as a layer that is tightened and heavily stretched on the inner wall surface of the mold. At this time, the clearances between the particles of the magnetic powder in the internal part of the molding have not been sufficiently reduced (see LC). The subsequent execution of the high-temperature pressure molding increases the friction between the dense stretched layer near the end surfaces and the inner wall surface of the mold, hindering the pressure applied by the punches from being transmitted to the internal part of the molding. This may prevent rearrangement that reduces the clearances between the particles of the magnetic powder in the internal part of the molding, and may make the insufficiently packed particles of the magnetic powder in the internal part of the molding more unlikely to be packed.

Therefore, the pressure molding step is preferably executed in an order of the high-temperature pressure molding and the low-temperature pressure molding. The first execution of the high-temperature pressure molding reduces the clearances between the particles of the magnetic powder in the internal part of the molding and increases the density (see HC). At this time, the clearances between the particles of the magnetic powder near the end surfaces of the molding have not been sufficiently reduced (see HE). The subsequent execution of the low-temperature pressure molding is performed under the condition that the clearances between the particles of the magnetic powder in the internal part of the molding is reduced, so that the insufficiently packed particles of the magnetic powder near the end surfaces (the surfaces with which the punches come into contact) of the molding can be further significantly packed (see LE). In other words, this pressure molding step is expected to further increase the density of the molding as a whole as compared to the case where only the high-temperature pressure molding is performed.

Alternatively, the pressure molding step may be executed in an order of the low-temperature pressure molding and the high-temperature pressure molding. Even in an uneven state where the density is excessively high near the end surface E as a result of the first execution of the low-temperature pressure molding, the subsequent execution of the high-temperature pressure molding increases the density in the internal part of the molding. This allows a reduction in the unevenness of the density of the molding as a whole, that is, the variation in density between the internal part and the ends of the molding. Therefore, this pressure molding step is expected to further increase the density of the molding as a whole as compared to the case where only the low-temperature pressure molding is performed.

Subsequently, as illustrated in step S7 in FIG. 1, heat treatment is executed in which the molding is heated to cure the binder 41. The heating temperature for the molding may be equivalent to the curing temperature T4 (curing start temperature) of a thermosetting silicone composition as depicted in FIG. 7 but may be equal to or higher than T4. However, the heating temperature is lower than the decomposition temperature T2 of the magnetic powder 11. For example, heating in the present step can be performed by setting the temperature in the pressurizing mold 70 equal to the curing temperature T4 without demolding the molding 50 formed using the pressurizing mold 70 in the preceding pressurizing step (step S6) from the pressurizing mold 70. Heating at the curing temperature T4 is continued until curing of the binder 41 is completed. A magnet 81 in the present embodiment can be manufactured after undergoing the above steps.

In the present embodiment, the step of performing binding on the molding using the silicone composition has been described. However, the step of thermally treating the molding 50 can be executed by any other method such as a method based on thermal oxidation. Specifically, an oxide film is formed on the magnetic powder, and the particles of the magnetic powder are joined together via the oxide film. At this time, a coating step may be additionally executed as needed. Specifically, the outer surface of a molding with the particles of the magnetic powder therein joined together is electroplated to provide a plated coating layer on the outer surface of the molding.

In the magnet 81 in the present embodiment, a cured binder 42 binds the particles of the coated magnetic powder 12 together as depicted in a schematic diagram in

FIG. 6.

The cured binder 42 is interposed only near the contact portions of the particles of the coated magnetic powder 12. That is, the surface of the coated magnetic powder 12 or the surface of each of the particles of the magnetic powder 11 is partly exposed. Fine voids may remain between the particles. In this case, the adsorption film 22 is expected to remain on the surface of the magnetic powder 11.

A first effect of the manufacturing method in the present embodiment is as follows. The pressure molding in step S6 is executed which includes the high-temperature pressure molding in step R1 and the low-temperature pressure molding in step R2. This allows obtaining a molding 50, 51 that is, as a whole, evenly dense and increasing the residual magnetic flux density to enhance the magnetic characteristics of the molding of the magnet 81.

A second effect of the manufacturing method in the present embodiment is as follows. The high-temperature pressure molding in step R1 is firstly performed to avoid a situation where the parts (51e) of the molding 51 near the end surfaces E are compressed and densified in a concentrative manner in the first step. In other words, it is possible to avoid a situation where the applied pressure is unlikely to be transmitted to the internal part (51c) due to the curing or stretching in the vicinities (51e) of the end surfaces E resulting from the concentrated compression, during the next step of either the high-temperature pressure molding or the low-temperature pressure molding. Consequently, a denser molding 50, 51 can be obtained.

A third effect of the manufacturing method in the present embodiment is as follows. The high-temperature (or low-temperature) pressure molding in step R1 and the low-temperature (high-temperature) pressure molding in step R2 are alternately performed to enable the internal part 51c of the molding 51 and the vicinities 51e of the end surfaces E to be alternately made denser. This allows the density of the molding as a whole to be more efficiently increased.

A fourth effect of the manufacturing method in the present embodiment is as follows. Since the low-temperature pressure molding in step R2 is performed at the end, particularly if the high-temperature pressure molding in step R1 is performed last, the molding 50, 51 is likely to have been thermally expanded. The molding 50, 51 is subsequently cooled for the low-temperature pressure molding in step R2, and is thus expected to be finally shrunk. Accordingly, clearances are likely to be formed between the cluster of particles of the magnetic powder 11 e and the cluster of particles of the magnetic powder 11c. The low-temperature pressure molding step is executed at the end so as to reliably fill up the clearances near the boundary between the internal part of the molding 50, 51 and each of the end surfaces of the molding 50, 51 (the boundary between the magnetic powder 11e and the magnetic powder 11c, in other words, the boundary that is between the part denoted by reference numeral 51 e and the part denoted by reference numeral 51c and that is located near the end surfaces), so that a denser moldings 50, 51 can be effectively obtained.

The manufacturing method in the present embodiment uses, as the magnetic powder 11 of a hard magnetic substance, a compound containing one or more of Fe—N-based compounds and R—Fe—N-based compounds (R: rare earth elements). A fifth effect of the manufacturing method in the present embodiment is that this configuration allows inexpensively manufacturing a magnet. The manufacturing method in the present embodiment does not require using dysprosium (Dy). That is, a magnet can be inexpensively manufactured. The manufacturing method in the present embodiment is preferable for obtaining a dense molding containing magnetic powder of the Fe—N-based compound or the R—Fe—N-based compound, which has a decomposition temperature lower than a sintering temperature and for which no molding technique has hitherto been established other than molding of the compound into a bond magnet.

The magnet 81 in the present embodiment is manufactured by the manufacturing method. This configuration allows the magnet to exert the above-described first to fifth effects.

What is claimed is:

1. A manufacturing method for a magnet, comprising:
performing pressure molding in which mixed powder of magnetic powder and a lubricant is molded under pressure so as to promote cracking of the magnetic powder and rearrangement of particles to obtain a molding of the magnetic powder, wherein
the pressure molding includes high-temperature pressure molding in which the mixed powder is pressurized and decompressed at a high elevated temperature equal to or higher than a melting point of the lubricant and equal to or lower than a decomposition temperature of the magnetic powder, and low-temperature pressure molding in which the mixed powder is pressurized and decompressed at a relatively low temperature lower than the melting point of the lubricant.

2. The manufacturing method according to claim 1, wherein
in the pressure molding, the high-temperature pressure molding is firstly performed.

3. The manufacturing method according to claim 1, wherein
in the pressure molding, the high-temperature pressure molding and the low-temperature pressure molding are repeatedly alternately performed.

4. The manufacturing method according to claim 2, wherein
in the pressure molding, the high-temperature pressure molding and the low-temperature pressure molding are repeatedly alternately performed.

5. The manufacturing method according to claim 1, wherein
in the pressure molding, the low-temperature pressure molding is performed last.

6. The manufacturing method according to claim 1, wherein
the magnetic powder contains powder of a hard magnetic substance that contains one or more of Fe—N-based compounds and R—Fe—N-based compounds (R: rare earth elements).

7. A magnet manufactured by the manufacturing method as claimed in claim 1.
